(19) United States
(12) Patent Application Publication
(10) Pub. No.: US 2022/0180066 A1
(43) Pub. Date: Jun. 9, 2022

(54) MACHINE LEARNING PROCESSING PIPELINE OPTIMIZATION

(71) Applicant: Singularity Systems Inc., Princeton, NJ (US)

(72) Inventor: Tianhao Wu, Princeton Junction, NJ (US)

(73) Assignee: Singularity Systems Inc., Princeton, NJ (US)

(21) Appl. No.: 17/600,253

(22) PCT Filed: Apr. 6, 2020
(86) PCT No.: PCT/IB2020/000338

§ 371 Date: Sep. 30, 2021

Related U.S. Application Data
(60) Provisional application No. 62/831,539, filed on Apr. 9, 2019.
(60) Provisional application No. 62/829,567, filed on Apr. 4, 2019.

(51) Int. Cl. G06F 40/284; G06N 20/00; G06K 9/62

(52) U.S. Cl. CPC G06F 40/284; G06K 9/6257; G06N 20/00

(57) ABSTRACT

A system and method for machine learning training provide a master AI subsystem for training a machine learning processing pipeline, the machine learning processing pipeline including machine learning components to process an input document, where each of at least two of the candidate machine learning components is provided with at least two candidate implementations, and the master AI subsystem is to train the machine learning processing pipeline by selectively deploying the at least two candidate implementations for each of the at least two of the machine learning components.

### CROSS-REFERENCE TO RELATED APPLICATIONS

This application claims the benefit of U.S. Provisional Application Nos. 62/829,567 filed Apr. 4, 2019 and 62/831,539 filed Apr. 9, 2019, the contents of which are incorporated herein in their entirety.

### TECHNICAL FIELD

This disclosure relates to machine learning, and in particular to optimization of a machine learning processing pipeline using AutoML.

### BACKGROUND

To apply machine learning to the application, a user of the AutoML may need to select methods that perform data pre-processing, feature extraction, and feature selection that convert the application data into formats suitable for machine learning. The user may further need to perform algorithm selection and hyperparameter optimization to maximize the performance of the final machine learning model.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 shows a machine learning system including a processing pipeline according to an implementation of the disclosure.

FIG. 2 illustrates a machine learning system including a master AI subsystem for training according to an implementation of the disclosure.

FIG. 3 illustrates some exemplary feature hierarchy according to an implementation of the disclosure.

FIG. 4 illustrates a flowchart of a method for training a machine learning model according to an implementation of the disclosure.

FIG. 5 depicts a block diagram of a computer system operating in accordance with one or more aspects of the present disclosure.

### DETAILED DESCRIPTION

As these tasks require expert knowledge about data (e.g., the knowledge of a data scientist) and thus beyond the ability of non-expert users, AutoML is often used to facilitate the implementations of machine learning. Automated machine learning (AutoML) is the process of automating the end-to-end process (referred to as a “processing pipeline” hereinafter) of applying machine learning to an application.

To achieve more efficient machine learning, implementations of the disclosure provide a general platform of AutoML (referred to as “master AI”) and in particular, a general AutoML platform for nature language processing (NLP) applications. Machine learning platforms commonly provide a processing pipeline including a series of components such as data selection, data labeling, data rebalancing, data format conversion, domain knowledge markup, document parser, tokenization, feature engineering, feature selection, algorithm selection, and hyper-parameter optimization. The platform according to implementations of the disclosure provides many different candidates implementations of these steps or components, and utilizes AutoML to choose, based on rules, the optimal implementation for each machine learning component for a particular application.

The master AI system according to the implementations may provide the advantages of optimizing the entire machine learning processing pipeline instead of just optimizing the algorithms and hyper-parameters. Implementations may split each machine learning step into smaller chunks, and then use AutoML to reassemble them together to optimize the overall machine learning results. Implementations may also provide many unique practical candidate methods for each machine learning step so that AutoML can provide different candidate implementations to be used to optimize the overall result.

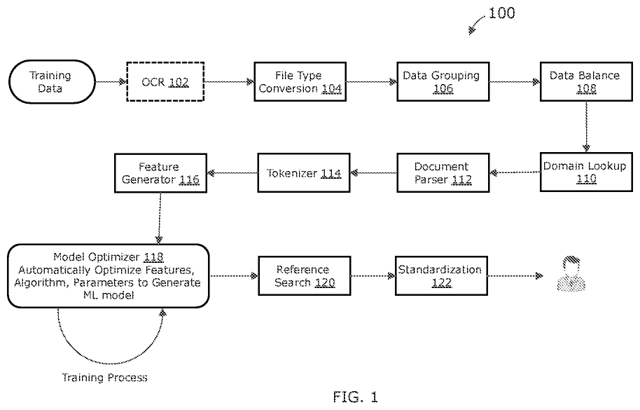

FIG. 1 shows a machine learning system 100 including a processing pipeline according to an implementation of the disclosure. In this implementation, a machine learning system 100 may include a processing pipeline for processing the input training data (e.g., a document) to generate an output (e.g., a formatted datasheet containing information to be extracted and stored in a data storage). The machine learning system may be trained through a training process so that it may generate the desired results. The processing pipeline may include an optional preprocessing component 102 (e.g., an OCR component including image preprocessing, OCR, and OCT postprocessing), a file type conversion component 104, a data grouping component 106, a data balancing component 108, a domain look-up component 110, a document parser component 112, a tokenization component 114, a feature generation component 116, a model optimizer component 118, a reference search component 120, and a standardization component 112. In the training processing, the training data (e.g., a document) may be sequentially processed through these components to generate the test results. An automated machine learning (e.g., AutoML) may compare the test results with pre-labeled training results to assess whether the machine learning system satisfies the performance requirements. These components perform the following functions: detecting the input file format, and converting the detected file format to a particular format (e.g., the HTML format) at 104; clustering group input data according the meaning of the input data at 106; filtering out the non-informative subsets of the input data at 108; deciding which domain knowledge fact sets should be used upon the input data at 110; parsing the input data into a document object model (DOM) tree comprising nodes of sentences and paragraphs at 112; tokenizing the contents of the nodes in the DOM tree at 114; generating universal NLP features across domains and languages at 116; optimizing, based on training, the machine learning model at 118, this including determining the optimized combination of features, determining the optimized language models across multiple languages for the input dataset, identifying the optimized machine learning algorithms for the input dataset, and optimizing hyper-parameters for the input dataset; determining the conditions when to lookup the reference data for post processing at 120; assembling the post processing methods to standardize the output format and correct potential errors at 122.

In this implementation, the components 102-116 in pipeline positions prior to model optimizer component 118 are pre-processing components, and the components 120, 122 in pipeline positions after optimizer component 118 are post-processing components. The pre-processing components and post-processing components are pre-determined and are not subject to change during the training process. The machine learning pipeline may include a machine learning model specified by a set of parameters. During training, the training data may be fed through the processing pipeline. Based on the output results, the parameters associated with the machine learning model may be adjusted by the AutoML according to a training rule (e.g., a gradient descendent algorithm) in a direction that minimizes the error rate at the output.

The implementation as shown in FIG. 1 adjusts parameters of the machine learning model through the training process, but does not make changes to other components during the training process. Thus, the performance of the implementation as shown in FIG. 1 is limited by how much the AutoML can improve the model optimizer component 118. To further improve the machine learning system, implementations of the present disclosure provide candidate implementations for not only the model optimizer component 118 but also other components. Further, implementations of the present disclosure provide a master AI system that may, in addition to adjusting the model optimizer component 118, select one or more candidate implementations for some of other components during the training process, thereby achieving further performance improvements.

The master AI system may split each of the machine learning components into subcomponents and then reassemble a selection of the subcomponents to optimize the overall performance of the machine learning system. The data input into each component may be divided into small units. Different types of data units may be optimally processed by corresponding different subcomponents. The master AI system may determine correspondences between a type of data units and the corresponding subcomponent during training, and then reassemble processed data units at the output of the component. In this way, the master AI system can train the machine learning system as a whole to achieve an overall superior performance compared to the system 100 as shown in FIG. 1. It should be noted that although the candidate implementations of each components may be provided, the combination of different implementations to form the machine learning processing pipeline is determined through training automatically using AutoML, thus eliminating the cost associated with relying upon the expertise of a data scientist.

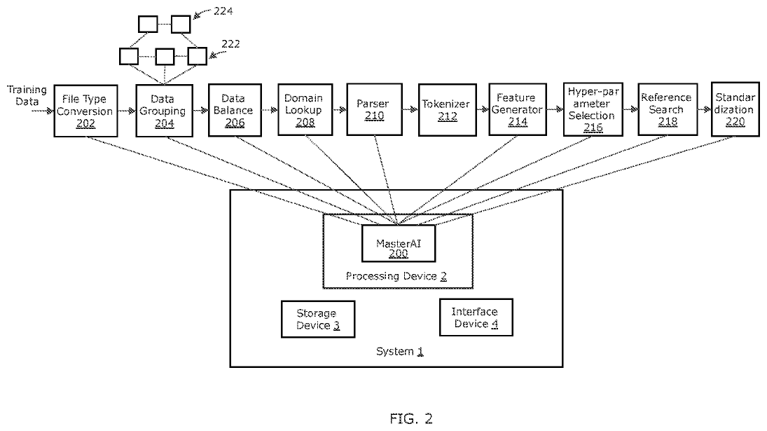

FIG. 2 illustrates a machine learning system 1 including a master AI subsystem 200 for training according to an implementation of the disclosure. Referring to FIG. 1, system 1 may support the implementation of the master AI subsystem 200. System 1 may include a processing device 2, a storage device 3, and a user interface device 4, where the storage device 3 and the user interface device 4 are communicatively coupled to processing device 2.

Processing device 2 can be a hardware processor such as a central processing unit (CPU), a graphic processing unit (GPU), or an accelerator circuit. User interface device 4 may include a display such as a touch screen of a desktop, laptop, or smart phone. User interface device 4 may further provide a graphical user interface that the user may interact with elements presented on the graphical user interface using an input device such as a mouse or touch screen. The graphical user interface may be implemented using a web browser, Java UI, C# UI, etc. For a concise description, the graphical user interface is also referred to as the user interface 4. Storage device 3 can be a memory device, a hard disc, or a cloud storage connected to processing device 2 through a network interface card (not shown). Processing device 2 can be a programmable device that may be programmed to present user interface 4 on the user interface device. User interface 4 can be a graphical user interface (“GUI”) that allows a user using an input device (e.g., a keyboard, a mouse, and/or a touch screen) to interact with graphic representations (e.g., icons) thereon.

In one implementation, system 1 may support a master AI subsystem 200 implemented using processing device 2. Master AI subsystem 200 may be used to train a machine learning processing pipeline including a number of machine learning components for processing input data. In this disclosure, the input data can be an input document, and the machine learning processing pipeline as a whole is trained to process the input document and generate an output containing information extracted from the input document, where the information can be stored in a database in storage device 3. A set of the machine learning components (e.g., two or more components) may each provide two or more candidate implementations of that component. Master AI subsystem 200 may then, in a training process, optimize the machine learning processing pipeline by selectively deploying the two or more candidate implementations of the set of machine learning components. In this way, the master AI subsystem 200 may train the machine learning processing pipeline.

As shown in FIG. 2, the machine learning processing pipeline may include, but not limited to, a file conversion component 202, a data grouping component 204, a data balancing component 206, a domain look-up component 208, a document parser 210, a tokenization component 212, a feature generation component 214, a hyper-parameter selection component 216, a reference search component 218, and a standardization component 220. As discussed above, master AI subsystem 200 may split each of the machine learning components 202-220 into subcomponents and then reassemble a selection of the subcomponents to optimize the overall performance of the machine learning system. The data input into each component may be divided into small units. For example, as shown in FIG. 2, a component (e.g., component 204) may include multiple candidate implementations 222 (referred to as “subcomponents”). Master AI subsystem 200 may select some of subcomponents 224 to resemble them during the training process. Different types of data units may be optimally processed by corresponding different subcomponents. The master AI subsystem 200 may determine correspondences between a type of data units and the corresponding subcomponent during training, and then reassemble processed data units at the output of the component.

In one implementation, each component is provided with multiple candidate methods or toolkit for master AI subsystem 200 to choose. Different methods/toolkits can fit different applications. Given an input dataset, the optimal method/toolkit can be chosen by master AI subsystem 200 based on the type of different datasets.

In one implementation, the file conversion component 202 may provide candidate file converters that each converts the input document from a source file type to a target file type. The master AI subsystem 200 may select one of the candidate file converters based on the source type, where the source file type can be one of a docx, .pdf, .txt, .html, .xml, .msg, email, JSON, .xlsx, .png, or .jpg format, and the target file type is .html. Master AI subsystem 200 may first detect the input file format and then convert input file into HTML. Alternatively, master AI subsystem 200 may subdivide the input training data into type, where each group contains a common type of source input data. The master AI subsystem 200 may choose a proper file type converter corresponding to the type of the source input data to convert data in different types.

The data grouping component 204 can be implemented to identify, in the input document, one or more data items corresponding to a same meaning but in different formats, and group the one or more data items into a common group. For example, data items of different data formats such as “2019-04-01” and “May 1, 2019” that correspond to a same category of meaning (e.g., dates) may be grouped into a same group. Master AI subsystem 200 may process different groups differently. For each group, master AI subsystem 200 may learn the following: matching the input data with pre-installed domain knowledge, sentence-to-sentence model, matching data with machine learning model, or manually-defined data specified according to user's specific requirement.

In practical applications, the input data provided to the machine learning processing pipeline can be unbalanced. Unbalanced data refers to a multi-class dataset having unequal numbers of instances for different classes. In machine learning, unbalanced classes may cause the training process to generate a model that has a high accuracy due to the dominant classes. But the model may not reflect a good fit for the minority classes. Therefore, it is desirable to balance the training dataset prior to being employed for training purpose. The data balancing component 206 may be equipped with many unique solutions to address the imbalance of data. In one implementation, data balancing component 206 may provide candidate implementations of different data balance schemes including an informative down-sampling, a down-up sampling, and a minority-class-oriented active sampling. Master AI subsystem may, in the training process, test all of them and determine the best resampling method for a given input data or a group of data items in the input data.

Using document processing as an example, the informative down-sampling approach may determine major classes and minor classes based on counts of samples in different classes, and then down-sample the majority class(es) by detecting and keeping the most informative samples. The informative down-sampling approach may perform clustering the majority class(es) based on the document data similarity (string, formatting, and meaning) using a distance measurement between two clusters. The function to calculate the distance measurement can be more than a simple string similarity function as most of traditional ML clustering. Instead, the distance measurement function can be a combination of all the string, formatting (e.g. table, layout, location, etc.), and content meanings (e.g. word embedding).

The informative down-sampling approach may further perform locating the center sample(s) from each cluster, and keeping these center samples as the down-sampled instances in the majority classes. Implementations of the disclosure may use a radius from the center of each cluster to pick up remaining samples. The size of radius is determined by the down-sampled class having a substantially similar number of samples as the original minority class(es) to balance the number of samples in different classes, where the substantially similar number may mean that the down-sampled majority class(es) includes a same level (e.g., 10s, 100s) of numbers as the minority class(es).

Compared to randomly down-sampling the majority class(es), the informative down-sampling is superior because it covers the informative data samples (represented by different clusters) and reduce the redundant data samples (represented by the samples inside the same cluster). And the center of a cluster is usually the most meaningful sample in one cluster.

The down-up sampling approach may first down-sample the majority class(es), and then up-sample the mis-classified majority class samples. The down-up sampling approach may perform:
1. down-sampling a majority class to make a balanced training set, and placing those unused majority class samples in a pool;
2. proceeding to train the machine learning model using the balanced data;
3. applying the trained machine learning model on the instances in the pool of unused majority class samples;
4. collecting mis-classified instances (these mis-classified instances are the boundary cases among majority and minority classes);
5. increasing the majority class instances by adding mis-classified instances into the training set;
6. adjusting the weight assigned to minority class(es) to make the dataset balanced again;
7. repeating steps 2 through 6 until the cross-validation test score reaches a certain number (e.g., three) of continuous drops (which means the up-sampling makes the evaluation worse) or there are no errors in step 4 (which means that the training set is perfectly separated).

In most of the unbalanced dataset, the minority class samples are difficult to identify, and in most of the cases, the minority class samples are more important than the majority class samples. It means that missing of minority class samples may have much more impact than missing majority class samples. One way to solve this problem is to locate potential minority class samples and present them to human experts to actively verify whether these candidate minority class samples found by the master AI subsystem 200 are actually the real minority class samples or not. The minority-class-oriented active sampling approach may achieve this by performing:
1. training a balanced machine learning model, which can be achieved by any resampling method that can balance the dataset (e.g., the informative down-sampling and down-up sampling);
2. applying a balanced machine learning model on unlabelled data;
3. if the balanced machine learning model identifies any minority class documents, then presenting the minority class document on a user interface to allow an expert operator to verify and confirm the data, and then adding the labelled data to the training set;
4. if the machine learning model identifies majority class instances with ambiguous score (low confidence <=0.5), then presenting the ambiguous majority class document on the user interface to allow the expert operator to verify and label the document, where the low confident score ones are near to the boundary of the majority and minority classes. Therefore, they may need manual labelling since the amount of ambiguous data can be small, and it is very likely containing minority class examples.

In the above-identified data balance implementations, the master AI subsystem 200 may not only balance the input data, but also identify most informative data and marginal data for different groups.

The domain look-up component 208 may contain domain knowledge bases. The master AI subsystem 200 may receive the input data and look up the domain knowledge bases based on the received data items. Exemplary domain knowledge databases may include US/UK/CA/AU Street Names, US/UK/CA/AU City Names, US/UK/CA/AU States, US/UK/CA/AU Postal Codes, US/UK/CA/AU Company Name Suffix, US/UK/CA/AU Phone Numbers, US/UK/CA/AU Organization Names, English Person First Names, English Person Last Names, Swift codes, World-wide Bank Names, Chinese Province Name and Locations, Chinese City Names, Chinese Organization Names, Chinese Phone Numbers, Chinese Tax IDs and Tax Rates, Chinese Last Names, Email Addresses, Date Formats, Sex, Occupations, Educations, Races etc. The master AI subsystem 200 may load different knowledge databases based on the application. The domain knowledges are used in data grouping, tokenizer, feature generation, and data post-processing procedure.

The document parser 210 may generate a document object model (DOM) tree based on the input data in the HTML type. The DOM tree may include nodes, where each node of the DOM tree may include one of a sentence or a paragraph contained in the input document.

The tokenization component 212 may provide candidate implementations of tokenizers such as a universal tokenizer, an entropy-based on-demand tokenizer, or other types of tokenizers. The master AI subsystem may select one of the universal tokenizer or the entropy-based on-demand tokenizer based on the data items, and tokenize the nodes of the DOM tree using the selected tokenizer.

A universal tokenizer may use certain linguistic identifiers in the sentences or paragraphs to generate tokens. A token is a basic unit in the document that can be detected by the machine learning model. Thus, a token can be a word, a number, or an alphanumerical string. For Western languages such as English, Spanish etc., the universal tokenizer may use whitespace identifiers (e.g., \t, \n, space, \r) and punctuation identifiers (e.g., “,” “.” “:” “;” etc.) that separate strings to identify the strings as tokens. Each punctuation itself is also a token, while a white space will be ignored. Empty token will also be ignored. For Eastern languages such as Chinese, Japanese, Korea, etc., the universal tokenizer may use each single character including punctuations as a token. White spaces may be ignored. The universal tokenizer can be applied to any human languages. For example, an English sentence of “this is a post-processing method.” can be split by the universal tokenizer into eight tokens of “this”, “is”, “a”, “post”, “-”, “processing”, “method”, and “.”. A Chinese sentence of “ [symbol] [symbol] ” can be split by the universal tokenizer into nine tokens of [symbol] [symbol] and “ [symbol] ”.

An entropy-based on-demand tokenizer may use advanced probabilistic concept modelling to learn token boundary in the labeled training data. For the information extraction (entity recognition) problem, master AI subsystem 200 may use the characters (either Western or Eastern languages) most enclosing a gold entity string as candidate boundary separators. A gold entity string is a token labeled by the expert operator on the user interface. The master AI subsystem 200 may compute the entropy value of each candidate separator surrounding the gold entity string. If the entropy value is smaller than a threshold value r (e.g. r<=0.1), then the candidate separators will be the final separators for tokenization. For the candidate character whose entropy is greater than 0.1, master AI subsystem 200 may use the two adjacent characters as the separator, and perform the same entropy test until all the boundaries in the training set can be perfectly split. The string between any two of the final separators will become a token. For example, training data has two samples:

a. “[Invoice Number:12:345e]”

b. “{File No.:90-802}”

where “12:345e” and “90-802” are labeled as gold strings. There are three characters at the boundary between a gold string and a non-gold string. They are “:”, “]”, and “}”. In which “]” and “}” has entropy <0.1. “:” has entropy >=0.1. Therefore, master AI subsystem 200 may use two adjacent characters outside the gold string containing “:” as separator. In this case, there are two new separators “r:” and “.:”. Table 1 illustrates the entropy calculation results.

TABLE 1

| | In-Gold | In-Gold | | Token |
|---|---|---|---|---|
| Character | Count | Probability | Entropy | Separator |
| : | 1 | 1/13 | 0.2846 | No |
| ] | 0 | 0 | 0 | Yes |
| } | 0 | 0 | 0 | Yes |
| r: | 0 | 0 | 0 | Yes |
| .: | 0 | 0 | 0 | Yes |

The feature generation component 212 may include a universal natural language processing (NLP) feature generator to generate one of universal NLP features or a hierarchy of NLP features. The hierarchy of features may include a high level features representing domain knowledges and a low level features representing NLP characteristics. The master AI subsystem 200 may selectively use one of the universal NLP features of the hierarchy of NLP features.

The feature generation component 212 may automatically generate features in such a way that features cover the entire hierarchy of the meanings. For example, feature1 may be “a word is an upper-case word”, feature2 is “the first letter of a word is upper case”, feature3 is “all characters in a word is upper case. In this case, feature1 logically contains both feature2 and feature3. Implementations of the disclosure may narrow down each machine learning component pieces as small as possible.

Master AI subsystem 200 can generate nature language processing (NLP) features automatically. Compared to common machine learning models which require a data scientist to choose NLP features manually, master AI subsystem 200 is able to generate features directly from data without human intervention. All these features are universal to any NLP applications. These features can be used on any text-based machine learning models.

In addition to universal NLP features, master AI subsystem 200 may also provide features according to a hierarchy. There are two primary benefits of using hierarchal features. First, the low-level fine-grained features provide more dimensions in feature space. Therefore, a machine learning model can be used to classify objects more precisely. The smaller the individual feature, the more combinations of these features will be available to the master AI subsystem. Therefore, it is more likely to train a precise Machine learning model. The fine-grained features are for end-to-end pure machine learning. The smaller fine-grained features are (the small building blocks for Machine learning model), the more likely that these features are independent to each other. This may help most of AI algorithms to work well. Based on Bayes' theorem, independency of events is crucial for the prediction accuracy. Therefore, it is more likely an end-to-end machine learning model can be learned without human data scientist interaction with the model.

The second benefit of using hierarchal features is to use the high-level (more abstract) features to split feature space more quickly. The abstract features may represent human domain knowledges. The use of high-level features can speed up the machine learning process because it utilizes the existing knowledge base. In a practical application, the master AI subsystem 200 may use high-level features in as many places as possible (and as early as possible) to quickly build the rough model that can split instances. If there are still ambiguous instances, then the master AI subsystem may drill down the feature hierarchy to use more fine-grained features to further split instances.

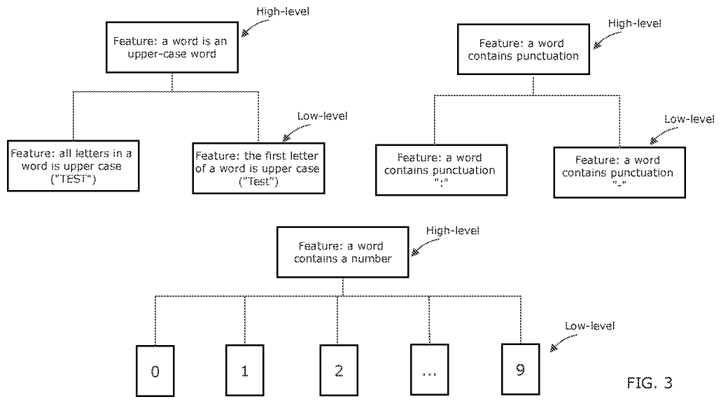

FIG. 3 illustrates some exemplary feature hierarchy according to an implementation of the disclosure. The automatic feature generation component 214 may generate more than 1,000,000 features for one dataset. Master AI subsystem 200 may go through the feature hierarchy to select important subset of features automatically and quickly. After the feature selection process, features will be reduced to around a few thousands without losing meaning features.

The hyper-parameter selection component 216 may provide candidate machine learning algorithms for the master AI subsystem 200 to select during the training process. The master AI subsystem 200 may selectively use at least one of the candidate machine learning algorithms based on the type of the input data, and adjust parameters specifying the at least one machine learning algorithm in a training process using the input data.

Master AI subsystem 200 may choose a suitable machine learning algorithm for each unique dataset from the pre-built candidate machine learning algorithms, where the dataset can be constructed based on its category and group and may be balanced. One or more algorithms can be selected to train machine learning models. And the final models will be ensembled together to become a final model. The candidate machine learning algorithms may include, but not limited to, linear regression, logistic regression, decision tree, support vector machine (SVM), naïve Bayesian, gradient boosting machine (e.g., lightGBM), or neural network models. The machine learning models may be initialized with starting parameter values (e.g., default parameter values) that may be iteratively adjusted to optimal parameter values in the model training stage. Properly trained machine learning models may be used to recognize information in a document in a recognition stage. The properly trained machine learning models may help achieve a target error rate and recall rate in the recognition stage.

The reference search component 218 may provide diverse data input sources. The master AI subsystem 200 may cross-validate validity of data from the diverse data input sources. An application often is associated with more than one input sources. Master AI subsystem 200 can use information from different input sources to cross-validate validity of data from different sources. For example, for commercial banks, information extracted from a new account application form can be verified by the applicant's driver's license, other account information with the bank, SSN background check, etc. In certain situations, customers have internal databases which may contain multiple information sources that can be used for cross validation. Master AI subsystem 200 may collect all available pre-existing information and use the information to correct its extraction or classification results.

The cross validation may include performing the regular information extraction (IE) or classification; searching the existing reference information including historical dataset finished by human, reference dataset, data warehouse, publicly available data in the Internet; using key fields (defined by the customer and the application) to fuzzy match with the reference data; retrieving the whole record of reference data; correcting the errors on the IE or classification with the reference data record.

The standardization component 220 may provide candidate post-processing methods. The master AI subsystem 200 may selectively use one of the candidate post-processing methods to reformat the data items to an output format. The candidate post-processing methods may include pre-existing methods such as customer supplied pre-existing postprocessing rules (e.g., regular expression tester or regex), post-processing rules according to specific requirements, and pre-built machine learning model for selecting the best post-processing rules. Alternatively, the format can be learned through a sequence-to-sequence model.

As described above, Master AI subsystem 200 may optimize each component in the machine learning processing pipeline. To achieve the optimization, the master AI subsystem 200 may, during the training process, select from multiple candidate implementations of each component. The selection may be achieved automatically by AutoML. The master AI subsystem 200 may split and resemble data for each component. The data is divided into small chunks and resembled through AutoML. The master AI subsystem 200 may also optimize machine learning model. Master AI subsystem 200 may be equipped with unique data processing, feature engineering and various models to find the optimal combination of features and models. Compared to other implementations of AutoML, Master AI may optimize the entire machine learning processing pipeline rather than just optimize the algorithms and hyper-parameters.

Implementation of the Master AI relies less on human machine learning experts because it is an end-to-end automated learning process. Master AI can optimize the whole machine learning processing pipeline by providing multiple candidate methods for each step and using the optimal method for each step, as well as splitting data input for each step into small chunks and reassembles them through AutoML. Master AI is suitable for processing all kind of data, including low-quality data, and generates the results with the desired format.

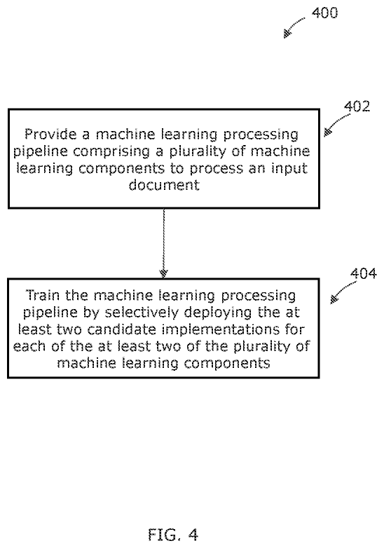

FIG. 4 illustrates a flowchart of a method 400 for training a machine learning model according to an implementation of the disclosure. Method 400 may be performed by processing devices that may comprise hardware (e.g., circuitry, dedicated logic), computer readable instructions (e.g., run on a general purpose computer system or a dedicated machine), or a combination of both. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 400 may be performed by a processing device 2 executing the master AI 200 as shown in FIG. 2.

As shown in FIG. 4, responsive to receiving a document, processing device 2 may, at 402, provide a machine learning processing pipeline comprising a plurality of machine learning components to process an input document, where each of at least two of the plurality of machine learning components is provided with at least two candidate implementations.

At 404, processing device 2 may train the machine learning processing pipeline by selectively deploying the at least two candidate implementations for each of the at least two of the plurality of machine learning components.

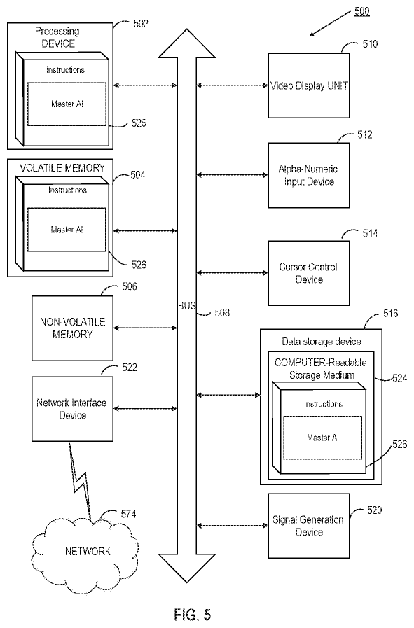

FIG. 5 depicts a block diagram of a computer system operating in accordance with one or more aspects of the present disclosure. In various illustrative examples, computer system 500 may correspond to the processing device 2 of FIG. 1.

In certain implementations, computer system 500 may be connected (e.g., via a network, such as a Local Area Network (LAN), an intranet, an extranet, or the Internet) to other computer systems. Computer system 500 may operate in the capacity of a server or a client computer in a client-server environment, or as a peer computer in a peer-to-peer or distributed network environment. Computer system 500 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 may include a processing device 502, a volatile memory 504 (e.g., random access memory (RAM)), a non-volatile memory 506 (e.g., read-only memory (ROM) or electrically-erasable programmable ROM (EEPROM)), and a data storage device 516, which may communicate with each other via a bus 508.

Processing device 502 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 500 may further include a network interface device 522. Computer system 500 also may include a video display unit 510 (e.g., an LCD), an alphanumeric input device 512 (e.g., a keyboard), a cursor control device 514 (e.g., a mouse), and a signal generation device 520.

Data storage device 516 may include a non-transitory computer-readable storage medium 524 on which may store instructions 526 encoding any one or more of the methods or functions described herein, including instructions of master AI 200 of FIG. 2 for implementing method 400.

Instructions 526 may also reside, completely or partially, within volatile memory 504 and/or within processing device 502 during execution thereof by computer system 500, hence, volatile memory 504 and processing device 502 may also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A system comprising one or more computers and one or more storage devices storing instructions that when executed by the one or more computers cause the one or more computers to implement:
a master AI subsystem for training a machine learning processing pipeline, the machine learning processing pipeline comprising a plurality of machine learning components to process an input document,
wherein each of at least two of the plurality of machine learning components is provided with at least two candidate implementations, and
wherein the master AI subsystem is to train the machine learning processing pipeline by selectively deploying the at least two candidate implementations for each of the at least two of the plurality of machine learning components.

2. The system of claim 1, wherein the plurality of machine learning components comprise a file conversion component, a data grouping component, a data balancing component, a domain look-up component, a document parser, a tokenization component, a feature generation component, a hyper-parameter selection component, a reference search component, and a standardization component.

3. The system of claim 2, wherein the file conversion component provides a plurality of file converters that each converts the input document from a source file type to a target file type, and wherein the master AI subsystem is to select one of the plurality of file converters based on the source type.

4. The system of claim 3, wherein the data grouping component is to:
identify, in the input document, one or more data items corresponding to a same meaning but in different formats; and
group the one or more data items into a common group, wherein the master AI subsystem is to process data items according to groups.

5. The system of claim 4, wherein the data balancing component comprises at least two of an informative down-sampling implementation, a down-up sampling implementation, or a minority-class-oriented active sampling implementation, and
wherein the master AI subsystem is to select one of the at least two of the informative down-sampling implementation, the down-up sampling implementation, or the minority-class-oriented active sampling implementation based on a test run on the data items in the input document using each of the at least two of the informative down-sampling implementation, the down-up sampling implementation, or the minority-class-oriented active sampling implementation.

6. The system of claim 5, wherein the domain look-up component comprises a plurality of domain knowledge bases, and wherein the master AI subsystem is to receive the data items of the input document and to look up the plurality of domain knowledge bases based on the received data items.

7. The system of claim 6, wherein the document parser is to generate a document object model (DOM) tree based on the data items of the input document, and wherein each node of the DOM tree comprises one of a sentence or a paragraph.

8. The system of claim 7, wherein the tokenization component comprises a universal tokenizer and an entropy-based on-demand tokenizer for generating tokens, and wherein the master AI subsystem is to:
select one of the universal tokenizer or the entropy-based on-demand tokenizer based on the data items; and
tokenize the nodes of the DOM tree using selected one of the universal tokenizer or the entropy-based on-demand tokenizer.

9. The system of claim 8, wherein the feature generation component comprises a universal natural language processing (NLP) feature generator to generate one of universal NLP features or a hierarchy of NLP features using the tokens, wherein the hierarchy of features comprise a high level features representing domain knowledges and a low level features representing NLP characteristics, and wherein the master AI subsystem is to selectively use one of the universal NLP features or the hierarchy of NLP features.

10. The system of claim 9, wherein the hyper-parameter selection component provides a plurality of machine learning algorithms, and wherein the master AI subsystem is to selectively use at least one of the plurality of machine learning algorithms based on the data items, and adjust parameters specifying the at least one of the plurality of machine learning algorithms in a training process using the data items.

11. The system of claim 10, wherein the reference search component provides a plurality of data input sources, and wherein the master AI subsystem is to cross-validate validity of the data items from the plurality of data input sources.

12. The system of claim 11, wherein the standardization component provides a plurality of post-processing methods, and wherein the master AI subsystem is to selectively use one of the plurality of post-processing methods to reformat the data items to an output format.

13. A method for training a machine learning system, the method comprising:
providing a machine learning processing pipeline comprising a plurality of machine learning components to process an input document, wherein each of at least two of the plurality of machine learning components is provided with at least two candidate implementations; and
training the machine learning processing pipeline by selectively deploying the at least two candidate implementations for each of the at least two of the plurality of machine learning components.

14. The method of claim 13, wherein the plurality of machine learning components comprise a file conversion component, a data grouping component, a data balancing component, a domain look-up component, a document parser, a tokenization component, a feature generation component, a hyper-parameter selection component, a reference search component, and a standardization component.

15. The method of claim 14, wherein the data balancing component comprises at least two of an informative down-sampling implementation, a down-up sampling implementation, or a minority-class-oriented active sampling implementation, the method further comprising:
selecting one of the at least two of the informative down-sampling implementation, the down-up sampling implementation, or the minority-class-oriented active sampling implementation based on a test run on the data items in the input document using each of the at least two of the informative down-sampling implementation, the down-up sampling implementation, or the minority-class-oriented active sampling implementation.

16. The method of claim 15, wherein the document parser is to generate a document object model (DOM) tree based on the data items of the input document, and wherein each node of the DOM tree comprises one of a sentence or a paragraph.

17. The method of claim 16, wherein the tokenization component comprises a universal tokenizer and an entropy-based on-demand tokenizer for generating tokens, the method further comprising:
selecting one of the universal tokenizer or the entropy-based on-demand tokenizer based on the data items; and
tokenizing the nodes of the DOM tree using selected one of the universal tokenizer or the entropy-based on-demand tokenizer.

18. The method of claim 17, wherein the feature generation component comprises a universal natural language processing (NLP) feature generator to generate one of universal NLP features or a hierarchy of NLP features using the tokens, wherein the hierarchy of features comprise a high level features representing domain knowledges and a low level features representing NLP characteristics, and wherein the master AI subsystem is to selectively use one of the universal NLP features or the hierarchy of NLP features.

19. The method of claim 18, wherein the hyper-parameter selection component provides a plurality of machine learning algorithms, and wherein the master AI subsystem is to selectively use at least one of the plurality of machine learning algorithms based on the data items, and adjust parameters specifying the at least one of the plurality of machine learning algorithms in a training process using the data items.

20. A machine-readable non-transitory storage media encoded with instructions that, when executed by one or more computers, cause the one or more computer to train a machine learning system, to:
provide a machine learning processing pipeline comprising a plurality of machine learning components to process an input document, wherein each of at least two of the plurality of machine learning components is provided with at least two candidate implementations; and
train the machine learning processing pipeline by selectively deploying the at least two candidate implementations for each of the at least two of the plurality of machine learning components.
